(19) United States
(12) Patent Application Publication
(10) Pub. No.: US 2009/0016741 A1
(43) Pub. Date: Jan. 15, 2009

(54) OPTICAL COMMUNICATION

(76) Inventors: David W. Smith, Ipswich (GB); Richard Wyatt, Ipswich (GB); Alistair J. Poustie, Ipswich (GB)

Correspondence Address: NIXON & VANDERHYE, PC, 901 NORTH GLEBE ROAD, 11TH FLOOR, ARLINGTON, VA, 22203, US

(21) Appl. No.: 12/278,315

(22) PCT Filed: Jan. 11, 2007
(86) PCT No.: PCT/GB07/00082

§ 371 Date: Aug. 5, 2008

(30) Foreign Application Priority Data
Feb. 10, 2006 (GB) 0602751.0

(51) Int. Cl. H04B 10/00

(52) U.S. Cl. 398/158

(57) ABSTRACT

The present invention relates to a method of optical communication, in particular optical communication involving spectral filtering in a passive optical network. The method includes the steps of: (i) performing a first spectral filtering function on a source signal having a spectral width so as to generate a plurality of feeder signals that are spectrally spaced apart from one another; (ii) performing a respective noise reduction function on the feeder signals; (iii) combining the feeder signals over a common waveguide of the optical link; (iv) receiving the feeder signals carried over the optical link and modulating the received feeder signals so as to impose data thereon; and, (v) returning the modulated feeder signals over the optical link so as to communicate the imposed data. Because noise is reduced centrally, a simpler passive optical network can be achieved.

The present invention relates to optical communication, in particular optical communication involving spectral filtering.

Spectral slicing of a broadband source to provide individual wavelength channels which can be subsequently modulated is an alternative to using stable single frequency lasers or tunable lasers within wavelength division multiplexed (WDM) systems, for example in a WDM passive optical network (PON). In such a system, it is known to use each wavelength channel as a respective feeder signal in order to receive data at a central receiver station from one or more of a plurality of remote transmitter stations. A respective feeder signal is transmitted to each transmitter station (each feeder signal having a different wavelength), where data is modulated onto the feeder signal. The modulated feeder signal with the data thereon is then returned to the receiver station from each central station.

Spectral slicing is a known technique for generating the feeder signals, but suffers from the problems of excess noise generated by the slicing process. It is known to reduce the effect of excess intensity noise within a spectrally sliced WDM PON by using a reflective SOA to modulate each return channel of the PON. However, this approach requires the use of a reflective SOA as a modulator at each customers terminal, whereas this may not always be convenient.

According to the present invention, there is provided a method of communicating over an optical link, including the steps of:

(i) performing a first spectral filtering function on a source signal having a spectral width so as to generate a plurality of feeder signals that are spectrally spaced apart from one another, each feeder signal having a reduced spectral width relative to the source signal;
(ii) performing a respective noise reduction function on the feeder signals;
(iii) subsequently to step (ii), combining the feeder signals such that the combined feeder signals can be carried over a common waveguide of the optical link;
(iv) receiving the feeder signals carried over optical link and modulating the received feeder signals so as to impose data thereon; and,
(v) returning the modulated feeder signals over the optical link so as to communicate the imposed data.

Because a noise reduction function is performed on the feeder signals before the feeder signals are modulated, a greater design freedom is provided over the type of modulator which can be employed to modulate signals. Furthermore, because the feeder signals are subject to noise reduction before being combined for transmission over a common waveguide, the risk is reduced that excessive noise will be introduced if the feeder signals are subsequently separated again (using a spectral filtering or slicing technique for example).

Preferably, the noise reduction function on the feeder signals will be performed by passing each feeder signal through a respective noise reduction element having a non-linear characteristic. The noise reduction element will preferably have an input and an output, the relationship between the input and output optical intensity, also known as the transfer function, being non non-linear in a region where the intensity of the feeder signals varies due to the noise thereon.

Each noise reduction elements will preferably be arranged to carry a respective feeder signal such that the feeder signals are spatially separated from one another. This may be achieved by arranging each noise reduction element such that each has a waveguiding region, through which the feeder signals are guided. The waveguiding regions of each noise reduction element will preferably be sufficiently separated from one another so as to reduce the risk of significant leakage form one noise reduction element to another. In a preferred embodiment, the each noise reduction element is formed by a respective semiconductor optical amplifier.

Preferably, the feeder signals received over the optical link will have been carried over a common waveguide in a combined fashion, in which case a second spectral filter function will preferably be performed on the combined feeder signals, such that the feeder signals can be individually modulated. Preferably, each of the first and second spectral filter functions will have a filter width associated therewith which determined the spectral width of each feeder signal, the filter width being such that for a given feeder signal, the spectral width of the first filter function is greater than that of the second filter function. This will reduce the likelihood that significant additional noise will be generated when the second filter function is performed.

In a preferred embodiment, a modulated feeder signals are returned over the same waveguide as that used to carry the signals to the point of modulation. However, the modulated feeder signals may be returned along an additional waveguide, either following the same path or a divergent path to that of the waveguide carrying unmodulated feeder signals. In such as situation, the optical link may include the divergent paths.

The feeder signals upon which a noise reduction function is performed may each be a continuous wave signal rather than a signal having data modulated thereon. However, the feeder signals may include some data, such as timing data or other network-maintenance data.

A modulator that functions according to an electro absorption principle will preferably be used to modulate feeder signals, as such a modulator will normally have a low electrical power consumption. Each modulator may then receive data signals over electrical connections know as “twisted pairs” which are provided in existing telephony networks between a street cabinet customer terminals, the data signals being of sufficient power to drive the modulators, thereby reducing the need for an additional power supply. The data signals themselves are not necessarily powerful enough to drive the modulator directly. DC power can be fed from the customer terminal to allow the powering of some low-power electronics in the street cabinet.

According to a further aspect of the invention, there is provided apparatus for optical communication which includes: (i) filter means for performing a first spectral filtering function on a source signal having a spectral width so as to generate a plurality of feeder signals that are spectrally spaced apart from one another, each feeder signal having a reduced spectral width relative to the source signal; (ii) noise reduction means for performing a respective noise reduction function on the feeder signals; (iii) combiner means for combining the feeder signals such that the combined feeder signals can be carried over a common waveguide of the optical link

The combined feeder signal may be modulated locally before being transmitted, or the combined feeder signal may be received from a remote location. Modulated signals may then be returned to the remote location. Alternatively the modulated feeder signals may be transmitted to a further location.

At least one further aspects of the invention is provided in the claims. The present invention will now be described in further details below, by way of example, with reference to the following drawing in which:

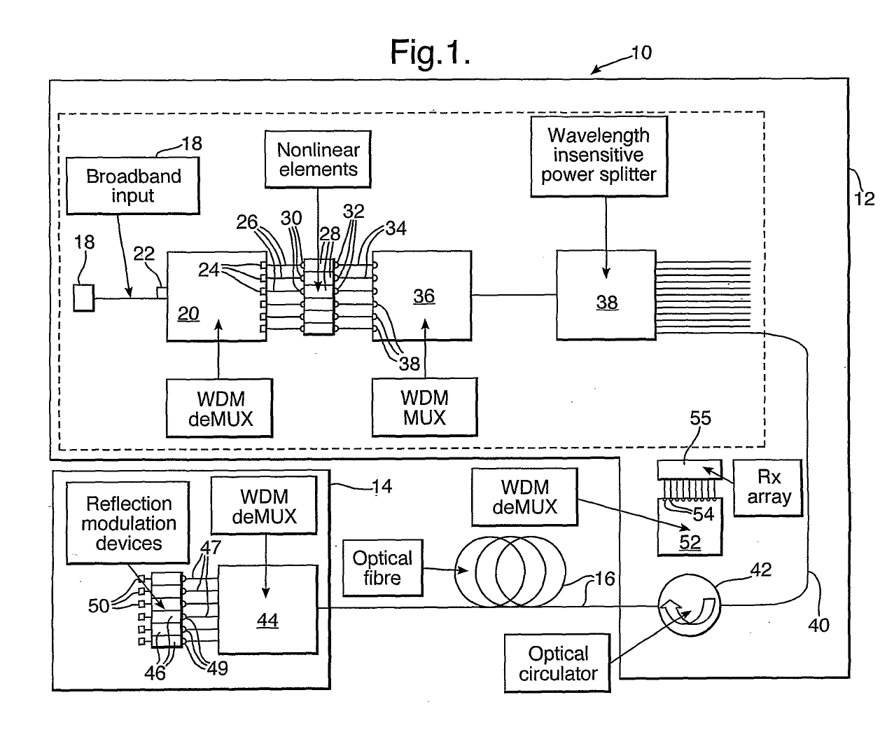

FIG. 1 shows a communication system according to the present invention;

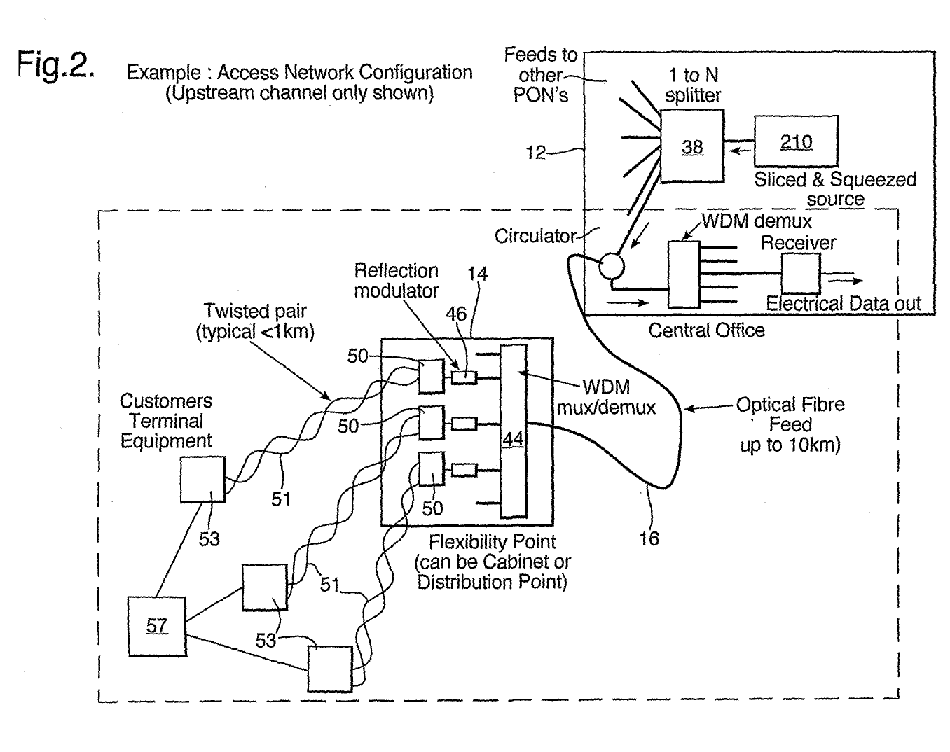

FIG. 2 shows further communications system;

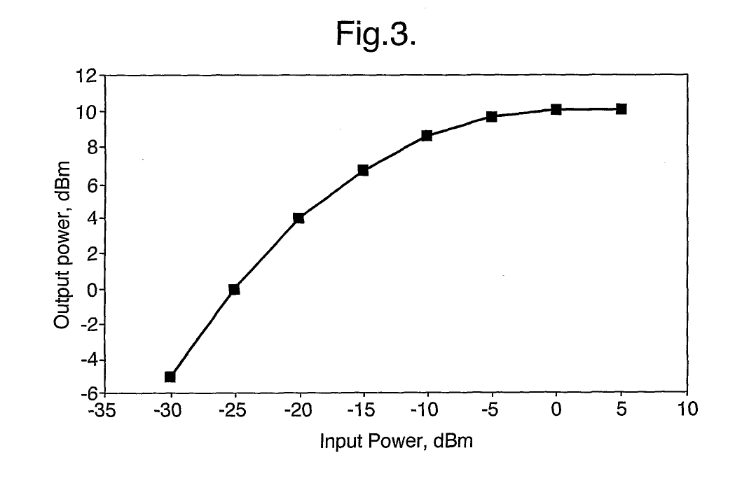

FIG. 3 shows a plot of one characteristic of an SOA

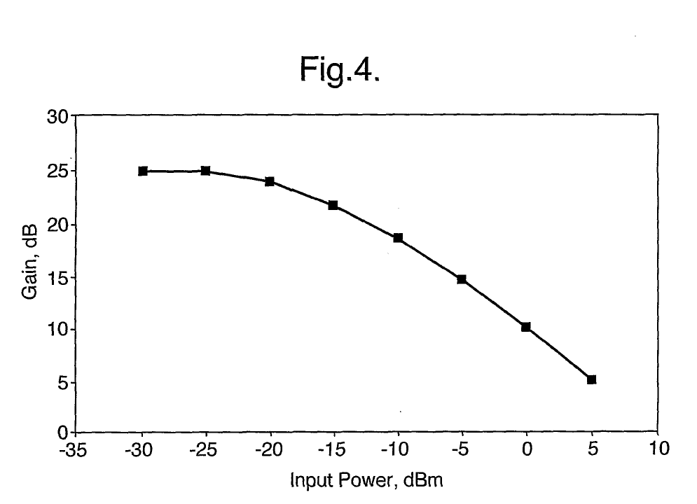

FIG. 4 shows a plot of another characteristic of an SOA

FIG. 1 shows an optical communication system 10 which includes a receiver station 12 connected to a transmitter station 14 by an optical transmission link 16, such that the receiver station 12 can receive modulated optical signals from the transmitter station 14 over a plurality of wavelength channels. The receiver station 12 includes a broadband light source which produces optical radiation within a wavelength (frequency) range. Here, the light source 18 is a Erbium doped fibre amplifier with a wavelength range of about 30 nm, centred at 1545 nm. The light source 18 is coupled to a spectral filtering element 20 which receives the broadband radiation from the light source 18 and spectrally separates the input radiation into a plurality of wavelength channels (feeder signals) each of which has a spectral width which is only a small portion of the wavelength range of the broadband light source 18. In this way, the spectral filtering element 20 serves to slice or otherwise divide the spectrum of the incident broadband light and thereby apportion part of the spectrum to each wavelength channel, in the manner of wavelength division multiplexing (WDM). The spectral filtering element 20 outputs each wavelength channel at a respective output port 24, each output port 24 being connected to a respective input waveguide 26, such that the radiation of the different wavelength channels is physically separated. Here, the spectral filtering element 20, also known as a wavelength division demultiplexer (WDM deMUX) is an arrayed waveguide device, here a planar element, having 32 outputs 24, each of which provides a wavelength channel of about 1.6 nm in spectral width.

Each output port 24 of the spectral filtering element is connected to a respective non-linear element 28 by a respective one of the waveguides 26. The non-linear elements 28 are each formed by a respective semiconductor optical amplifier (although another suitable travelling wave amplifier or other amplifier having suitable non-linear characteristics). Each amplifier has an (active) waveguiding region extending between an input and an output, which output is connected to a respective output waveguide 34. Thus, the radiation of each wavelength channel passes through a respective non-linear element 28 in a spatially separated manner (although there may be some leakage between adjacent non linear elements) before being recombined at a combiner element 36, here an arrayed waveguide (of similar design to the spectral filtering element 20). The combiner element 36 has a plurality of inputs 38 for receiving the different wavelength channels, and an output 40 for the output of a combined channel formed from the super position of the different channels. In this way, the combiner acts as a WDM multiplexer (WDM MUX). The combined channels will be of comparable spectral breadth to that of the broadband light source.

Light from the combined channel (carried over a common waveguide such as optical fibre) optionally passes through a power (intensity) splitter 38 so as to provide a plurality of duplicate combined channels, each having a reduced intensity relative to that incident at the splitter. The path of only one of the (duplicate) combined channels from the power splitter 38 is shown for clarity. The combined channel shown is carried along a waveguide path 40 to a circulator element 44, from where it is channeled along the transmission link 16 (each channel travelling on a common waveguide of the link) to a further spectral filtering 44 element (again an arrayed WDM deMUX waveguide with 32 output channels) at the transmitter station.

The spectral distribution of the spectral filtering elements 44,20 at the transmitter station 14 will be substantially matched, to the extent that the wavelength channels created at the receiver station 12 can be demultiplexed or otherwise recovered at the transmitter station 14. The spectral filtering element 44 at the transmitter station 14 includes a plurality of coupling waveguides 47, each of which carries a respective one of the recovered wavelength channels.

A respective modulator device 46 is coupled at a respective port 49 to each output waveguide. Each modulator device is driven by a respective electrical driver circuit 50 such that data can be independently modulated on each wavelength channel. Each modulator device 46 is a reflective modulator, having a reflector surface (normally on a back facet) such that light entering a modulator device at the port thereof performs a double path through a modulating medium of the modulator before exiting the modulator at the port 46. In this way, modulated light from each channel is returned over a respective coupling waveguide 47 to the spectral filtering element 44. In the return direction, the spectral filtering element 44 acts as a combiner, such that the modulated wavelength channels are combined to form a return combination channel. The return combination channel is carried over the optical link 16 towards the circulator element 42, where the circulator element 42 directs the light forming the return combination channel towards a receiver spectral filtering element 52. The receiver spectral filtering element 52 is configured to recover the modulation channels at a plurality of outputs 54 (one for each channel) in a similar fashion to the way in which the spectral filtering element 44 of the transmitter station 14 recovers the unmodulated channels from the (unmodulated) combined signal. An array of receivers 55 is provided (such as an array of photo-diodes) for converting the modulation signal (here an amplitude or intensity modulation) imposed on each of the wavelength channels into a respective electrical signal for each channel. In this way, information can be communicated from the transmitter station 14 to the receiver station 12 over the optical link 16.

Because the wavelength channels are transmitted between the transmitter and receiver station as a combined signal, the signals can be transmitted over an optical fibre, allowing existing installed fibre to be used to extend the reach of the communications system 10.

Each of the spectral filtering elements 20,44,52 will have a line width associated therewith which determined the spectral spread of the wavelength channels. Clearly, since noise due to the spectral filtering (that is, the restriction on the spectral spread of each wavelength channel) is reduced after the initial filtering at the receiver station, it is desirable to limit the additional noise, if any, introduced through the action of the filtering element 44 at the transmission station, as well as that of the receiver filtering element 52. It is therefore desirable to choose the line width of each filtering element such that as a wavelength channel progresses through the communication system after the initial filtering at the filter element 20 at the receiver station, the line width of the channels is not further reduced: that is, the line width of the initial filter 20 is less than that of the filter at the transmitter station, which in turn will be less than the line width of the receiver filter 55.

FIG. 2 shows an example of an access network configuration which uses the communication system outlined above with reference to FIG. 1. Here, the receiver station is located at a central office, from which an optical fibre feed extends to a remote cabinet or distribution point, at which the transmitter station of FIG. 1 is located. Each driver circuit 50, which is coupled to a respective modulator, is connected to a respective customer terminal by a twisted pair of electrical (preferably copper) wires 51. In this way, data entered at a terminal 53 will be carried over the twisted pair to the driver circuit 50 and subsequently converted into a modulated optical signal for transmission over the fibre feeds. Each customer terminal is connected to a central power unit, such as mains supply, from which it can draw electrical power. Each customer terminal is configured to transmit sufficient electrical power over the twisted pair to allow the modulator connected thereto to operate. In this way, the modulator will be powered by the data signal from the customer terminal to which it is connected, thereby reducing the need for a power supply at the cabinet or distribution point.

The system shown in FIG. 2 can be viewed as a wavelength division multiplex passive optical network (a WDM PON), in which the customer terminals 53 are optical network units (ONUs), and the cabinet or distribution point 14, together with the central office 12, represents an optical line terminal (OLT). Thus, modulated data signals from the ONUs are passively multiplexed at the combiner or multiplexer 44 (which acts as demultiplexer for feeder signals travelling in the opposite direction). The multiplexed signals are then carried over a common waveguide (here an optical fibre) to the central office.

Because the optical power splitter 38 is provided at the central office, the feeder signal or wavelength channels from the sliced and squeezed source 210 (with reference to FIG. 1, this is equivalent to the signal from the combiner element 36) can be used as a feeder signal to drive further PONs. In such a situation, the components within the dashed line of FIG. 2 may be connected to other outputs of the power splitter 38 in a similar fashion to that shown in FIG. 2.

The modulators will preferably each be an electro absorption modulator, also know an EAM, since such modulators require a particularly low electrical power to operate. However, other types of modulators may be used.

The role of a semiconductor optical amplifier (also know as an SOA) for each non linear element can be understood with reference to FIGS. 3 and 4, which respectively show the transfer characteristics and the gain of an SOA as a function of input power. As can be seen from FIG. 3, the output power is not proportional to the input power, and saturates at high input powers. Likewise, the gain decrease at high input powers. These properties are believed to be at least in part responsible for the noise reduction produced by an SOA.

An SOA has a quasi linear or almost linear region, and a non linear region where gain saturation occurs. Typically, onset of the non region is taken to be at about the 3 dB compression point, that is, the point in the gain curve (against input power) where the gain is reduced by 3 dB relative to its maximum value. With reference to FIG. 4, in the present example this occurs at an input power of −15 dBm: so the SOA would be operated at powers above −15 dBm.

The following additional comments are provided
The dashed box of FIG. 1 is shared resource (as between different PONs), through wavelength independent splitter 38. This would typically be passive fibre or planar silica splitter, but need not be passive for this architecture to work
Nonlinear element would preferably be SOA.
Depending on characteristics of following PON, SOA could be polarisation-independent, single-polarisation, or a hybrid device consisting of a polarisation splitter, two individual single-polarisation (or polarisation-independent) SOAs, and a polarisation combiner
Architecture as depicted has sliced broadband input, such as from EDFA, or superluminescent diode. Could also be source with spectral structure, such as multimode laser diode, or array thereof
Input into nonlinear elements has to have sufficient power to produce some saturation of the gain of the element (see following diagrams)
For the case depicted, where sliced broadband input is used, there will be a preferred relationship between the bandwidths of the various WDM devices. The input to the nonlinear element should have the narrowest bandwidth, with subsequent filter widths being wider. This is a function of the spectral broadening which occurs during the squeezing process; any spectral clipping after this point will reduce the degree of squeezing obtainable. This is a clear benefit of this architecture, compared with an architecture where the nonlinear device is disposed at the modulator end of the system. In this case, the input and output filters are necessarily the same width, as they are the same device. However, as the filter bandwidth becomes narrower, the intrinsic noise of the slice increases, and hence more squeezing is required to obtain a particular signal-to-noise ratio. Thus, there will be an optimum, not yet determined, filter width, for a given channel spacing, and broadband input power. Spectral broadening effects will also be reduced through use of an SOA with low alpha (phase-amplitude coupling) factor
Advantage over conventional array of DFB lasers, for example, is that the broad spectral width of the source reduces the effect of Rayleigh backscatter in the transmission fibre. Typically, this results in a noise floor in the received signal when a reflective architecture is used with a narrow-line laser source. The broad spectral width of the spectrally sliced source spread the backscattered energy over a wide frequency band, resulting in a much reduced noise spectral density within the region of interest, and hence improved signal-to-noise ratio

It is recognised for certain applications where electrical power is limited, for example the remote powering of equipment within a cabinet or distribution point, it would be preferential to use optoelectronic devices with very low power consumption such as electro-absorption modulators or other types of optical modulator using electrooptic effects for operation.

In the proposed new architecture the noise from a spectrally sliced broadband source is squeeze or otherwise reduced at the head-end (i.e. within the local exchange) using semiconductor optical amplifiers or by some other suitable non-linear element or optoelectronic process. This allows the remote reflective modulators to be of much lower power design, such as EAM, to be used without suffering noise penalties from the spectral slicing process. The intensity fluctuations for each wavelength of the sliced source has to individually squeezed using a non-linear SOA requiring N SOA's for N wavelengths. However, if a star coupler architecture is used within the headend of the WDM PON it is possible for N SOA's to be used to serve >N² remote terminations. Likely to be less sensitive to backscatter than narrowline coherent source.

Other Design Consideration: the use of a single polarisation SOA for performing squeezing may be useful if the transmission path between head end and remote terminal has significant polarisation dependency, and the remote modulator is substantially polarisation independent (the ability to squeeze each polarisation separately then combine the signals may be desirable)

### Probable Optimisation of Filter Shapes

Reduced alpha factor (amplitude-phase coupling) of noise-reducing amplifier would reduce spectral spreading
In certain cases chromatic dispersion of the fibre link may also need to be taken into account in deciding the spectral width of the sliced channels. Post amplification prior to squeezing may be necessary when very narrow sliced spectral widths are required.

The above embodiments provide a simple centralised noise reduction system.

1. A method of communicating over an optical link, including the steps of:
(i) performing a first spectral filtering function on a source signal having a spectral width so as to generate a plurality of feeder signals that are spectrally spaced apart from one another, each feeder signal having a reduced spectral width relative to the source signal;
(ii) performing a respective noise reduction function on the feeder signals;
(iii) subsequently to step (ii), combining the feeder signals such that the combined feeder signals can be carried over a common waveguide of the optical link;
(iv) receiving the feeder signals carried over the optical link and modulating the received feeder signals so as to impose data thereon; and,
(v) returning the modulated feeder signals over the optical link so as to communicate 20 the imposed data.

2. A method as claimed in claim 1, wherein the noise reduction function on the feeder signals is performed by passing each feeder signal through a respective noise reduction element having a non-linear characteristic.

3. A method as claimed in claim 1, wherein each feeder signal has noise associated therewith, which noise has the form of power level variations, and wherein the noise reduction function on the feeder signals is performed by passing each feeder signal through a respective noise reduction element having a transfer characteristic that responds in a non-linear fashion to the power level variations.

4. A method as claimed in claim 1, wherein the noise reduction function on the feeder signals is performed by passing each feeder signal through a respective noise reduction element, the noise reduction elements being arranged to carry the feeder signals such that the feeder signals are spatially separated from one another.

5. A method as claimed in claim 1, wherein each noise reduction element is formed by a respective semiconductor optical amplifier.

6. A method as claimed in claim 1, wherein a second spectral filter function is performed on combined feeder signals received over the optical link, such that the feeder signals can be individually modulated.

7. A method as claimed in claim 6, wherein each of the first and second spectral filter functions has a filter width associated therewith which determined the spectral width of each feeder signal, and wherein for a given feeder signal, the spectral width of the first filter function is greater than that of the second filter function.

8. A method as claimed in claim 6, wherein the modulated feeder signals are combined before being returned over the optical link.

9. A method as claimed in claim 7, wherein a the modulated feeder signals are returned over the common waveguide.

10. A method as claimed in claim 1, wherein the modulated feeder signals are returned over a further waveguide.

11. A method as claimed in claim 1, wherein a respective electro absorption modulator is used to modulate the feeder signals.

12. Apparatus for optical communication which includes:
(i) filter means for performing a first spectral filtering function on a source signal having a spectral width so as to generate a plurality of feeder signals that are spectrally spaced apart from one another, each feeder signal having a reduced spectral width relative to the source signal;
(ii) noise reduction means for performing a respective noise reduction function on the feeder signals;
(iii) combiner means for combining the feeder signals such that the combined feeder signals can be carried over a common waveguide of the optical link.

13. A method of communicating over an optical link, including the steps of
(i) performing a first spectral filtering function on a source signal having a spectral width so as to generate a plurality of feeder signals that are spectrally spaced apart from one another, each feeder signal having a reduced spectral width relative to the source signal;
(ii) performing a respective noise reduction function on the feeder signals;
(iii) subsequently to step (ii), combining the feeder signals and transmitting the combined feeder signals over a common waveguide of the optical link;
(iv) receiving the feeder signals transmitted over optical link and modulating the received feeder signals so as to impose data thereon; and,
(v) returning the modulated feeder signals over the optical link so as to communicate the imposed data.

14. A method of communicating over an optical link, including the steps of:
(i) performing a first spectral filtering function on a source signal having a spectral width so as to generate a plurality of feeder signals that are spectrally spaced apart from one another, each feeder signal having a reduced spectral width relative to the source signal;
(ii) performing a respective noise reduction function on the feeder signals;
(iii) subsequently to step (ii), combining the feeder signals such that the combined feeder signals can be carried over a common waveguide of the optical link; and
(iv) receiving the feeder signals carried over optical link and modulating the received feeder signals so as to impose data thereon.
